(19) United States
(12) Patent Application Publication
(10) Pub. No.: US 2023/0282922 A1
(43) Pub. Date: Sep. 7, 2023

(54) BATTERY MODULE

(71) Applicant: Prime Planet Energy & Solutions, Inc., Tokyo (JP)

(72) Inventor: Tetsuji OMURA, Kobe-shi (JP)

(21) Appl. No.: 18/175,542

(22) Filed: Feb. 28, 2023

(30) Foreign Application Priority Data
Mar. 1, 2022 (JP) 2022-030611

(51) Int. Cl. H01M 50/264; H01M 50/209; H01M 50/517

(52) U.S. Cl. CPC H01M 50/264; H01M 50/209; H01M 50/517

(57) ABSTRACT

An end plate is provided with a recess that is opened to a restraint member. The restraint member is provided with a through hole that communicates with the recess. A bolt includes a first portion passing through the through hole and the recess, and a second portion located on a tip side of the first portion. A clearance is formed between the first portion of the bolt and each of the through hole and the recess, and the second portion of the bolt is screwed into the end plate. A length of the first portion of the bolt is 40% or more of an underhead length of the bolt.

This nonprovisional application is based on Japanese Patent Application No. 2022-030611 filed on Mar. 1, 2022 with the Japan Patent Office, the entire contents of which are hereby incorporated by reference.

### BACKGROUND OF THE INVENTION

### Field of the Invention

The present technology relates to a battery module.

### Description of the Background Art

As described in Japanese Patent Laying-Open No. 2020-047573, it has been a conventional practice that an end plate is provided at an end portion of a stack of battery cells, and a restraint member that restrains the battery cells in a stacking direction and the end plate are fastened together by bolts.

Japanese Patent Laying-Open No. 2005-315387 discloses that a bolt is used for a fixation portion between a driving-side rotating body and a driven-side rotating body.

### SUMMARY OF THE INVENTION

When a plurality of members are fastened by a bolt, a load in a deflection direction acts on the bolt due to for example, a difference in linear expansion coefficient between the plurality of members or the like, with the result that force in a loosening direction acts on a seating surface of the bolt. When a screw-engaged portion is made long in order to suppress loosening of the bolt, a fastened structure can be increased in size. When the fastened structure is increased in size, the thickness of the end plate can be increased, thus resulting in an increased size of a battery module It is an object of the present technology to provide a downsized battery module.

A battery module according to the present technology includes: a stack including a plurality of battery cells arranged side by side in a first direction; an end plate provided at an end portion of the stack in the first direction; a restraint member fastened to the end plate to restrain the stack and the end plate in the first direction; and a bolt that fastens the end plate and the restraint member. The end plate is provided with a recess that is opened to the restraint member. The restraint member is provided with a through hole that communicates with the recess. The bolt includes a first portion passing through the through hole and the recess, and a second portion located on a tip side of the first portion. A clearance is formed between the first portion of the bolt and each of the through hole and the recess, and the second portion of the bolt is screwed into the end plate. A length of the first portion of the bolt is 40% or more of an underhead length of the bolt.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a battery module.

FIG. 2 is a perspective view showing a battery cell included in the battery module.

FIG. 3 is a diagram showing restraint members included in the battery module.

FIG. 4 is a diagram showing a state of a fastened structure of each end plate and the restraint members when viewed in a stacking direction (first direction) of battery cells.

FIG. 5 is a cross sectional view of a fastened structure according to a reference example.

FIG. 6 is a cross sectional view of a fastened structure according to one embodiment.

FIG. 7 is a cross sectional view showing a state in which the fastened structure shown in FIG. 6 is deformed.

FIG. 8 is a diagram for illustrating a structure in the vicinity of a bolt.

FIG. 9 is a diagram showing the bolt in a deformed state.

FIG. 10 is a diagram showing a state in which a fastened structure according to a modification is deformed.

FIG. 11 is a diagram showing a relation between a depth of a recess and reaction force acting on a seating surface of the bolt.

FIG. 12 is a diagram showing a relation between a length of a non-fastening portion and an underhead length of the bolt.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. in the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include another battery such as a nickel-metal hydride battery.

In the present specification, the “battery cell” can be mounted on vehicles such as a hybrid electric vehicle (HEV), a plug-in hybrid electric vehicle (PHEV), and a battery electric, vehicle (BEV). It should be noted that the use of the “battery cell” is not limited to the use in a vehicle.

FIG. 1 is a perspective view of a battery module 1 (except for a below-described restraint member 400). As shown in FIG. 1, battery module 1 includes battery cells 100, separator members 200, and end plates 300.

The plurality of battery cells 100 are battery cells each having a prismatic shape, and are provided along a Y axis direction (first direction). Separator members 200 are provided between the plurality of battery cells 100. Each of separator members 200 prevents unintended electrical conduction between adjacent battery cells 100. Separator member 200 secures an electrical insulation property between adjacent battery cells 100. End plates 300 are disposed at both ends of the stack of battery cells 100 and separator members 200 in the Y axis direction. Each of end plates 300 is fixed to a base such as a case that accommodates battery module 1.

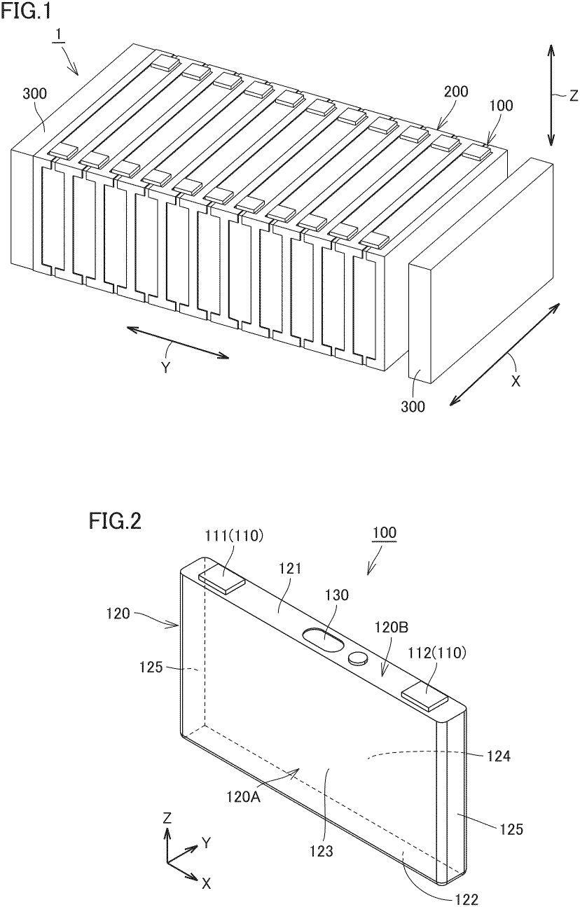

FIG. 2 is a perspective view showing a battery cell 100. As shown in FIG. 2, battery cell 100 has a prismatic shape. Battery cell 100 has electrode terminals 110, a housing 120, and a gas-discharge valve 130.

Electrode terminals 110 are formed on housing 120. Electrode terminals 110 have a positive electrode terminal 111 and a negative electrode terminal 112 arranged side by side along an X axis direction (second direction) orthogonal to a Y axis direction (first direction). Positive electrode terminal 111 and negative electrode terminal 112 are provided to be separated from each other in the X axis direction.

Housing 120 has a rectangular parallelepiped shape, and forms the external appearance of battery cell 100. Housing 120 includes: a case body 120A that accommodates an electrode assembly (not shown) and an electrolyte solution (not shown); and a sealing plate 120B that seals an opening of case body 120A. Sealing plate 120B is joined to case body 120A by welding.

Housing 120 has an upper surface 121, a lower surface 122, a first side surface 123, a second side surface 124, and two third side surfaces 125.

Upper surface 121 is a flat surface orthogonal to a Z axis direction (third direction) orthogonal to the Y axis direction and the X axis direction. Electrode terminals 110 are disposed on upper surface 121. Lower surface 122 faces upper surface 121 along the Z axis direction.

Each of first side surface 123 and second side surface 124 is constituted of a flat surface orthogonal to the Y axis direction. Each of first side surface 123 and second side surface 124 has the largest area among the areas of the plurality of side surfaces of housing 120. Each of first side surface 123 and second side surface 124 has a rectangular shape when viewed in the Y axis direction. Each of first side surface 123 and second side surface 124 has a rectangular shape in which the X axis direction corresponds to the long-side direction and the Z axis direction corresponds to the short-side direction when viewed in the Y axis direction.

A plurality of battery cells 100 are stacked such that first side surfaces 123 of battery cells 100, 100 adjacent to each other in the Y direction face each other and second side surfaces 124 of battery cells 100, 100 adjacent to each other in the Y axis direction face each other. Thus, positive electrode terminals 111 and negative electrode terminals 112 are alternately arranged in the Y axis direction in which the plurality of battery cells 100 are stacked.

Gas-discharge valve 130 is provided in upper surface 121. When the temperature of battery cell 100 is increased in an abnormal manner (thermal runaway) and internal pressure of housing 120 becomes more than or equal to a predetermined value due to gas generated inside housing 120, gas-discharge valve 130 discharges the gas to outside of housing 120.

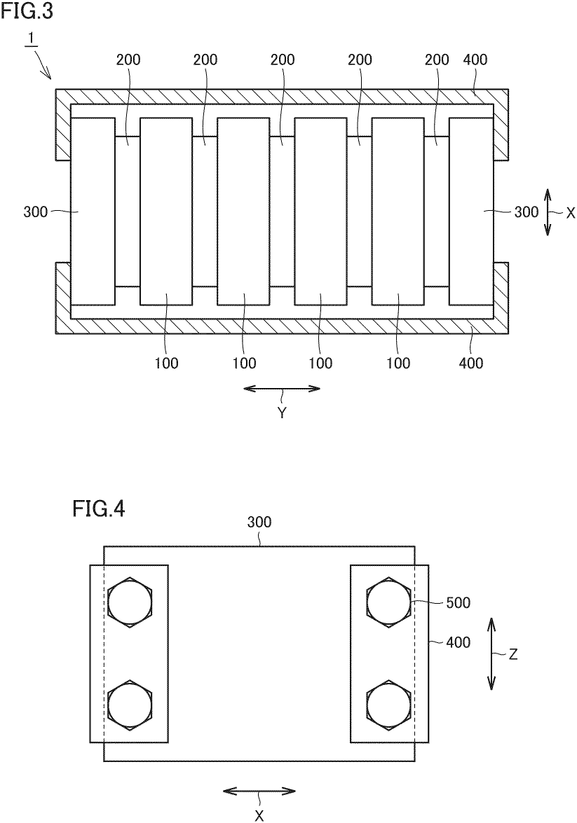

FIG. 3 is a diagram showing restraint members 400. As shown in FIG. 3, each restraint member 400 connects two end plates 300 together. Restraint member 400 is engaged with end plates 300 with compression force in the Y axis direction being exerted to the stack of the plurality of battery cells 100, separator members 200, and end plates 300, and then the compression force is released, with the result that tensile force acts on restraint member 400 that connects two end plates 300 to each other As a reaction thereto, restraint member 400 presses two end plates 300 in directions of bringing them closer to each other.

FIG. 4 is a diagram showing a state of a fastened structure of each end plate 300 and restraint members 400 when viewed in the Y axis direction. In each of FIG. 4 as well as FIGS. 5 to 10 described later, the size of each bolt 500 may be illustrated in an exaggerated manner.

As shown in FIG. 4, end plate 300 and each restraint member 400 are fastened by bolts 500. The plurality of (two in the example of the present embodiment) bolts 500 are provided side by side in the Z axis direction. Each of bolts 500 is provided along the Y axis direction and fastens end plate 300 and restraint member 400.

Thus, battery module 1 includes: the stack including the plurality of battery cells 100 arranged side by side in the Y axis direction; end plates 300 each provided at an end portion of the stack in the Y axis direction; restraint members 400 each fastened to end plates 300 to restrain battery cells 100, separator members 200, and end plates 300 in the Y axis direction; and bolts 500 that each fasten end plates 300 and restraint members 400.

FIG. 5 is a cross sectional view of a fastened structure according to a reference example. As shown in FIG. 5, restraint member 400 is provided with through holes 410, and bolts 500 pass through through holes 410 and are screwed into end plate 300.

For example, when end plate 300 is composed of aluminum and restraint member 400 is composed of iron, a displacement in the Z direction occurs at an interface between end plate 300 and restraint member 400 due to a difference in linear expansion coefficient therebetween. Since bolt 500 is screwed into end plate 300, the seating surface of bolt 500 is displaced together with restraint member 400 at the same time as the occurrence of the displacement in the Z direction at the interface between end plate 300 and restraint member 400, with the result that deflection force is generated. With frictional force (vertical drag × friction force = axial force × friction coefficient of the interface) acting on the interface between the seating surface of bolt 500 and restraint member 400 against the deflection force, the displacement of the interface between restraint member 400 and the seating surface of the bolt can be suppressed to some extent. When this deflection force (displacement force) becomes more than the frictional force to cause displacement of the interface between the seating surface of bolt 500 and restraint member 400, loosening rotational force can be generated onto the seating surface of bolt 500. In order to suppress loosening of bolt 500, the axial force can be increased to increase the frictional force; however, at the same time, it is necessary to secure strength of the screw-engaged portion between bolt 500 and end plate 300. In other words, when an underhead length (screw-engagement length) of bolt 500 is made long, the fastened structure can be increased in size.

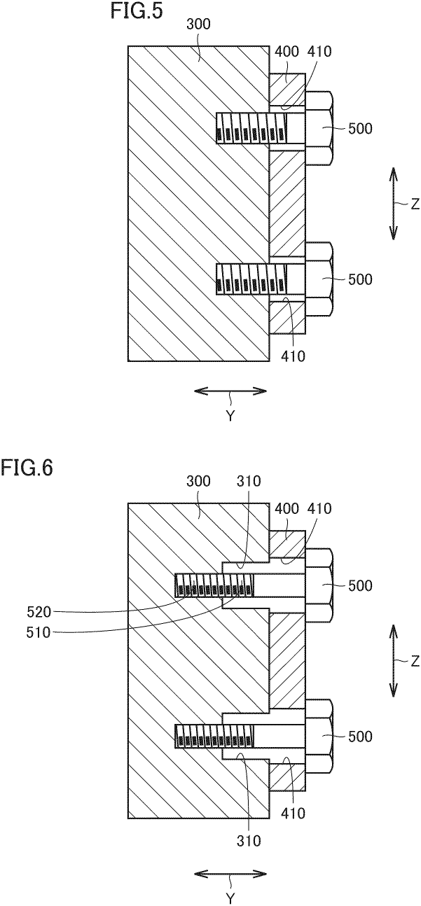

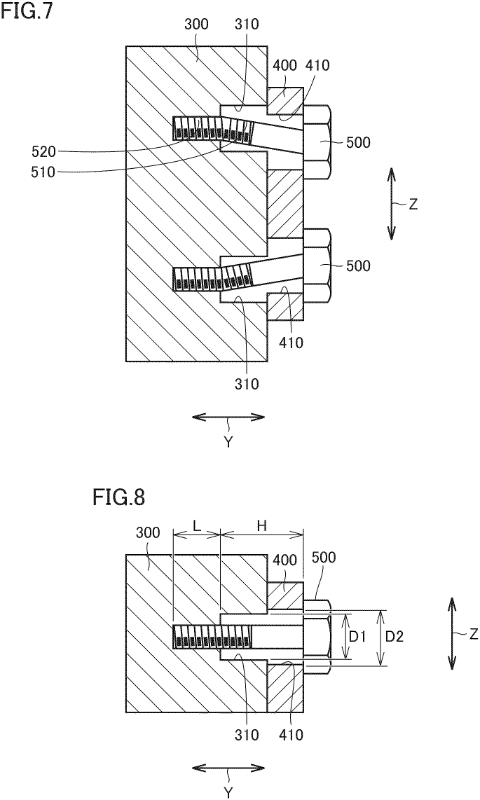

FIG. 6 is a cross sectional view of the fastened structure according to the present embodiment. FIG. 7 is a cross sectional view showing a state in which the fastened structure shown in FIG. 6 is deformed.

As shown in FIGS. 6 and 7, in the fastened structure according to the present embodiment, end plate 300 is provided with recesses 310 that are each opened to restraint member 400, and each of bolts 500 includes a first portion 510 (non-fastening portion) passing through through hole 410 and recess 310, and a second portion 520 (fastening portion) located on the tip side of first portion 510. A clearance is formed between first portion 510 of bolt 500 and each of through hole 410 and recess 310. Second portion 520 of bolt 500 is screwed into end plate 300.

In one embodiment, end plate 300 is composed of a material having a first linear expansion coefficient. Restraint member 400 is composed of a material having a second linear expansion coefficient different from the first linear expansion coefficient. As an example, end plate 300 is composed of aluminum, and restraint member 400 is composed of iron. In this case, the linear expansion coefficient of end plate 300 is larger than the linear expansion coefficient of restraint member 400. Specifically, the linear expansion coefficient of aluminum is about 23 µ/°C, and the linear expansion coefficient of iron is about 11.7 µ/°C. Therefore, the linear expansion coefficient of end plate 300 is about twice as large as the linear expansion coefficient of restraint member 400.

Thus, in the case where the linear expansion coefficient of end plate 300 and the linear expansion coefficient of restraint member 400 are different from each other, when a temperature change occurs during use of battery module 1, a difference in amount of deformation is resulted between end plate 300 and restraint member 400.

In the fastened structure according to the present embodiment, by forming recess 310 having an appropriate depth in end plate 300, even when displacement in an abutment surface direction occurs between end plate 300 and restraint member 400, deflection force (displacement force) between restraint member 400 and the seating surface of bolt 500 can be decreased by the deflection of bolt 500 as shown in FIG. 7, thereby suppressing the displacement As a result, the axial force of bolt 500 can be suppressed from being decreased without excessively increasing the underhead length of bolt 500.

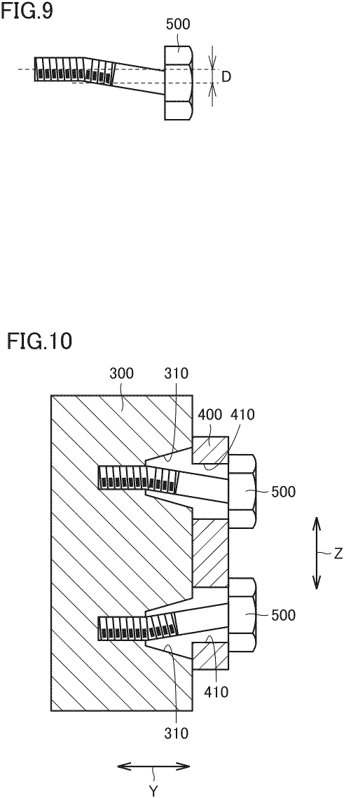

FIG. 8 is a diagram for illustrating a structure around bolt 500. FIG. 9 is a diagram showing bolt 500 in a deformed state.

As shown in FIG. 8, the opening of recess 310 has a first diameter (D1). The first diameter (D1) is found by the following formula (1):

$$\begin{matrix}\text{The first diameter} \left(\text{D1}\right) \geq \text{the bolt diameter +} \\ \left(\left[\text{the linear expansion coefficient of end plate 300}\right] -\right) \\ \left(\left[\text{the linear expansion coefficient of restraint member 400}\right]\right) \times \\ \left[\text{distance between position fastened by bolt 500}\right] \times \\ \left[\text{a target temperature difference when battery module 1 is used}\right] \times 2 = \\ \text{the bolt diameter + a line expansion amount} \times \text{2}\end{matrix} \qquad \text{(1)}$$

For example, when end plate 300 is composed of aluminum and restraint member 400 is composed of iron, assuming that the distance between positions fastened by bolt 500 is about 70 mm and the target temperature difference is about 45° C., the linear expansion amount is about 0.07 mm. The first diameter (D1) is determined to absorb the linear expansion amount by the deflection amount (D in FIG. 9) of bolt 500.

Through hole 410 of restraint member 400 has a second diameter (D2) In the example of FIG. 8, the second diameter (D2) is larger than the first diameter (D1). The second diameter (D2) may be substantially the same as the first diameter (D1).

The length (H) of first portion 510 and the length (L) of second portion 520 of bolt 500 are determined to cause bolt 500 to have an underhead length (H+L) as small as possible while securing the fastening force of bolt 500.

FIG. 10 is a diagram showing a state in which a fastened structure according to a modification is deformed. As shown in FIG. 10, each of recesses 310 of end plate 300 may have a tapered shape with a diameter increased toward the outside (the head side of bolt 500).

Each of recess 310 of end plate 300 and through hole 410 of restraint member 400 typically has a substantially circular shape (on the X-Z plane) when viewed in the Y axis direction. However, each of the shapes of recess 310 and through hole 410 is not limited thereto, and may be a shape with a length in the Z axis direction being longer than that in the X axis direction, for example.

FIG. 11 is a diagram showing a relation between a depth of recess 310 of end plate 300 and reaction force in the loosening direction acting on the seating surface of bolt 500 when deformed due to a temperature change. Second portion 520 (fastening portion) of bolt 500 is screwed into end plate 300, and the seating surface of bolt 500 is displaced together with restraint member 400 due to linear expansion, with the result that deflection force (displacement force) is generated at bolt 500. This deflection force (displacement force) serves as reaction force in the loosening direction between restraint member 400 and the seating surface of bolt 500. As shown in FIG. 11, when the depth of recess 310 is about 10 mm, the deflected portion of bolt 500 is short (rigidity is high), thus resulting in large reaction force in the loosening direction acting on the seating surface of bolt 500 when deformed due to temperature change. On the other hand, when the depth of recess 310 is about 20 mm or more, the deflected portion of bolt 500 is long (rigidity is low), thus resulting in decreased reaction force in the loosening direction acting on the seating surface of bolt 500 when deformed due to temperature change. As a result, the strength of the fastening portion of bolt 500 does not need to be excessively increased, so that the length of bolt 500 can be short. Therefore, the underhead length (H+L) of bolt 500 can be made short, thereby downsizing the fastened structure.

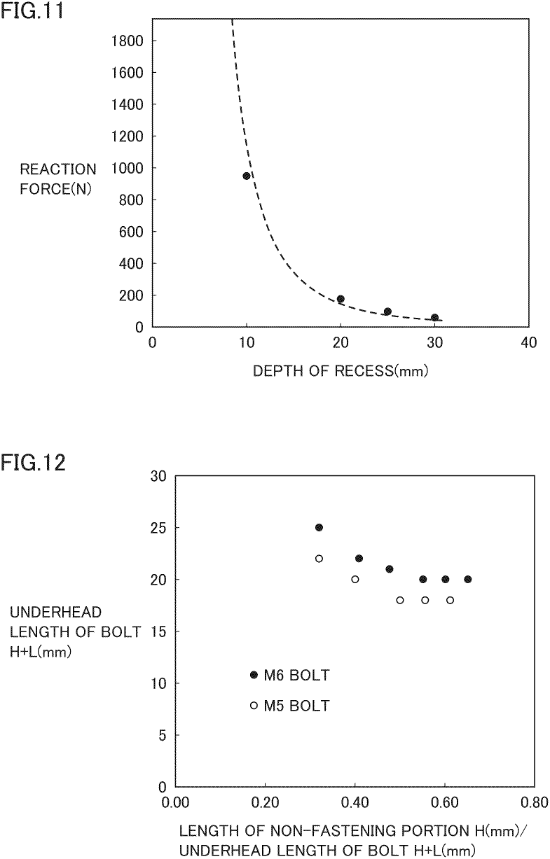

FIG. 12 is a diagram showing a relation between the length (H) of the non-fastening portion and the underhead length (H+L) of bolt 500. In the example of FIG. 12, the underhead length (H+L) of bolt 500 is assumed to be the length of second portion 520 by which minimally required fastening force of bolt 500 can be secured in consideration of deformation due to temperature change.

As shown in FIG. 12, when the length (H) of first portion 510 of bolt 500 is about 40% or more and 80% or less (preferably about 50% or more and 70% or less) of the underhead length (H+L) of bolt 500, the underhead length (H+L) of bolt 500 can be made short as a whole.

As described above, in battery module 1 according to the present embodiment, the deflection of bolt 500 can be permitted by forming recess 310 having an appropriate depth. As a result, even when displacement in the abutment surface (X-Z plane) direction occurs between end plate 300 and restraint member 400 due to reasons such as a difference in linear expansion coefficient between end plate 300 and restraint member 400, displacement between seating surface of bolt 500 and restraint member 400 can be prevented due to the deflection of bolt 500, thereby suppressing loosening (decreased axial force) of bolt 500.

Although the embodiments of the present invention have been described and illustrated in detail, it is clearly understood that the same is by way of illustration and example only and is not to be taken by way of limitation, the scope of the present invention being interpreted by the terms of the appended claims. The scope of the present invention is defined by the terms of the claims, and is intended to include any modifications within the scope and meaning equivalent to the terms of the claims.

What is claimed is:

1. A battery module comprising:
a stack including a plurality of battery cells arranged side by side in a first direction;
an end plate provided at an end portion of the stack in the first direction;
a restraint member fastened to the end plate to restrain the stack and the end plate in the first direction; and
a bolt that fastens the end plate and the restraint member, wherein
the end plate is provided with a recess that is opened to the restraint member,
the restraint member is provided with a through hole that communicates with the recess,
the bolt includes a first portion passing through the through hole and the recess, and a second portion located on a tip side of the first portion,
a clearance is formed between the first portion of the bolt and each of the through hole and the recess, and the second portion of the bolt is screwed into the end plate, and
a length of the first portion of the bolt is 40% or more of an underhead length of the bolt.

2. The battery module according to claim 1, wherein the bolt is provided along the first direction.

3. The battery module according to claim 1, wherein an opening of the recess has a first diameter, and the through hole has a second diameter larger than the first diameter.

4. The battery module according to claim 1, wherein
the bolt is provided along the first direction, and
an opening of the recess has a first diameter, and the through hole has a second diameter larger than the first diameter.

5. The battery module according to claim 1, wherein the end plate is composed of a material having a first linear expansion coefficient, and the restraint member is composed of a material having a second linear expansion coefficient different from the first linear expansion coefficient.

6. The battery module according to claim 5, wherein the end plate is composed of aluminum, and the restraint member is composed of iron.

7. The battery module according to claim 1, wherein
the bolt is provided along the first direction, and
the end plate is composed of a material having a first linear expansion coefficient, and the restraint member is composed of a material having a second linear expansion coefficient different from the first linear expansion coefficient.

8. The battery module according to claim 1, wherein
an opening of the recess has a first diameter, and the through hole has a second diameter larger than the first diameter, and
the end plate is composed of a material having a first linear expansion coefficient, and the restraint member is composed of a material having a second linear expansion coefficient different from the first linear expansion coefficient.

9. The battery module according to claim 1, wherein
the bolt is provided along the first direction,
an opening of the recess has a first diameter, and the through hole has a second diameter larger than the first diameter, and
the end plate is composed of a material having a first linear expansion coefficient, and the restraint member is composed of a material having a second linear expansion coefficient different from the first linear expansion coefficient.

10. The battery module according to claim 1, wherein each of the battery cells is a prismatic secondary battery cell.

11. The battery module according to claim 1, wherein
the bolt is provided along the first direction, and
each of the battery cells is a prismatic secondary battery cell.

12. The battery module according to claim 1, wherein
an opening of the recess has a first diameter, and the through hole has a second diameter larger than the first diameter, and
each of the battery cells is a prismatic secondary battery cell.

13. The battery module according to claim 1, wherein
the end plate is composed of a material having a first linear expansion coefficient, and the restraint member is composed of a material having a second linear expansion coefficient different from the first linear expansion coefficient, and
each of the battery cells is a prismatic secondary battery cell.

14. The battery module according to claim 1, wherein
the bolt is provided along the first direction,
an opening of the recess has a first diameter, and the through hole has a second diameter larger than the first diameter,
the end plate is composed of a material having a first linear expansion coefficient, and the restraint member is composed of a material having a second linear expansion coefficient different from the first linear expansion coefficient, and
each of the battery cells is a prismatic secondary battery cell.
